(19) United States
(12) Patent Application Publication
(10) Pub. No.: US 2004/0262261 A1
(43) Pub. Date: Dec. 30, 2004

(54) Methods and systems for creating layer-formed plastic elements with improved properties

(76) Inventors: Jeffrey E. Fink, West Hills, CA (US); Tracy L. Taylor, Semi Valley, CA (US); Lori A. Wegner, Santa Monica, CA (US); Mark Wilenski, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 10/608,272

(22) Filed: Jun. 27, 2003

(51) Int. Cl. B05D 3/06; C23F 1/00

(52) U.S. Cl. 216/66; 427/551; 427/558

(57) ABSTRACT

Methods and systems for changing properties of a layer-formed plastic part comprised of at least one plastic material are disclosed. In one embodiment, an electromagnetic radiation source is provided and the layer-formed plastic part is positioned within a potential exposure range of the electromagnetic radiation source. An exposure of radiation from the electromagnetic radiation source operable to change the property of the layer-formed plastic part from the existing state to an altered state is determined. The layer-formed plastic part is then exposed to the radiation to change the property of the layer-formed plastic part to the altered state.

### FIELD OF THE INVENTION

This invention relates generally to plastics manufacturing and, more specifically, to improving performance characteristics of plastic hardware generated using layer-formed manufacturing technologies.

### BACKGROUND OF THE INVENTION

Plastics have revolutionized design and manufacturing technologies. Plastics have replaced glass, metal, wood, and other materials in everything from product packaging to food containers to toys. Beyond plastics' widespread uses in creating containers and housings, plastic has even replaced metals in creating mechanical parts such as gears and levers. Only a few decades ago, creation of articulable parts involved stamping, forging, or casting such parts out of metal. However, forming parts from metal presented a number of drawbacks. For example, creating the dies or other devices used to form metal parts is relatively costly, particularly in the case of small, precision parts. As a result, producing small quantities of such metal parts generally proved to be impractically expensive. Furthermore, as compared to plastics, metals usually are heavier per unit volume, thus using metal parts results in a final product that might be heavier than desired. Clearly, the proliferation of plastics has improved this situation by providing means for creating such parts at a lower cost and having reduced weight.

Relatively new plastics manufacturing technologies further enhance the advantages of using plastics. Technologies such as selective laser sintering (SLS), fused deposition modeling (FDM), and other layer-forming technologies allow plastic parts to be manufactured in small quantities for prototyping and for application-specific uses. Such technologies can form plastic parts directly from computer design applications. Thus, SLS and FDM allow for production of parts without having to take the time to wait for creation of molds or other time-consuming processes used in conventional manufacturing technologies.

For example, using SLS technology, the plastic parts are created layer by layer. A layer of plastic powder is spread onto a build surface by an articulable mechanism that distributes the powder in place. A laser beam is used to sinter the power by selectively melting the plastic powder layer, thereby causing granules of powder in the layer to bond to each other. Also, if the layer of powder was disposed on a preexisting layer, the sintering process will bond the newly deposited layer to the preexisting sintered layer. The process is repeated layer by layer until the entire part is fabricated. Once the part is formed, excess plastic powder is brushed or blown away.

Using FDM technology, the plastic parts are also created layer by layer. Using FDM technology, however, the parts are created from filaments of plastic fiber rather than from plastic powder. The plastic filaments are unwound from a coil and fed to a heated extrusion nozzle. The heated nozzle melts the plastic fiber. The supply of plastic from the heated nozzle can be selectively started and stopped as the nozzle is moved across the layer being formed. As the nozzle dispenses plastic while being moved back and forth, a thin bead of extruded plastic is deposited to form each layer. The plastic hardens and bonds to the layer below, thereby forming the desired part.

Layer-formed technologies such as SLS and FDM allow for quick, cost-effective creation of small quantities of plastic parts. Thus, these layer-formed technologies are ideally suited for creating small quantities of parts that might be desired for prototyping or design-specific applications.

A potential disadvantage of plastic parts created using layer-formed technologies are the properties of these parts. Parts formed using such layer-formed technologies may lack desired strength or impact resistance that can be obtained from metal parts. Similarly, such parts might be too easily deformable or, alternatively, too brittle for desired applications. In addition, such parts may be unsuitable for the intended temperature range in which the part is intended to operate.

Therefore, there is an unmet need in the art for methods and systems for producing layer-formed plastic parts having tailorable properties such that the resulting parts have a desired strength, desired deformability, and other desired properties to suit objectives for the layer-formed plastic parts. At the same time, there is an unmet need to tailor properties without the hazards, toxic by-products and expense associated with other methods.

### SUMMARY OF THE INVENTION

The present invention comprises methods and systems for producing a layer-formed plastic part with selectively improved properties. The selectively improved properties result from controlled exposure of the layer-formed part, sections of the layer-formed part, or selected layers of the layer-formed part, to an exposure of radiation. A radiation source and the exposure to radiation generated by the radiation source are selected for cross-linking or chain-scissioning effects on a plastic material from which the layer-formed part is created. Cross-linking and/or chain-scissioning of the molecular chains of the plastic material allow the layer-formed part to be made more or less strong, more or less deformable, or modified in a number of other ways to achieve a desired result.

More specifically, the present disclosure is directed to methods and systems for changing a property of a layer-formed plastic part including at least one plastic material. An electromagnetic radiation source is provided and the layer-formed plastic part is positioned within a potential exposure range of the electromagnetic radiation source. An exposure of radiation from the electromagnetic radiation source operable to change the property of the layer-formed plastic part from the existing state to an altered state is determined. The layer-formed plastic part is then exposed to the radiation to change the property of the layer-formed plastic part to the altered state. As a result, a layer-formed part formed by selective laser sintering, fused deposition modeling, or a similar technique can be made to have more desirable properties.

In one embodiment of a method in accordance with the present invention, an existing state of the property of the layer-formed plastic part is recognized and a desired state of the property is identified. The exposure of radiation to change the property of the layer-formed plastic part is identified such that the altered state reaches the desired state.

In accordance with further aspects of the invention, the exposure of electromagnetic radiation may be controlled by moving at least one of the layer-formed plastic part and the electromagnetic radiation source. The layer-formed plastic part may be placed on a moving surface which moves relative to the source of the electromagnetic radiation. Alternatively, the source of the electromagnetic radiation may be moved relative to a surface on which the layer-formed plastic part is placed. Also, the exposure of radiation may be controlled by targeting discharge of radiation from the electromagnetic radiation source. The exposure of radiation may be controlled by manipulating magnetic fields through which the radiation from the electromagnetic radiation source will pass. In addition, the exposure of radiation may be controlled by selectively positioning a radiation-blocking shield between the layer-formed plastic part and the electromagnetic radiation source such that at least part of the layer-formed plastic part is shielded from the radiation source.

In accordance with further aspects of the invention, the property to be changed may be physical strength, elongation, modulus, impact resistance, operating temperature range, heat capacity, flammability, conductance, emittance, other electrical capacities, or another property. The electromagnetic radiation source and the exposure of radiation are selected to cross-link or chain-scission molecules of the plastic material to change the property of the layer-formed plastic part to the desired state. The electromagnetic radiation source suitably may be one of an electron beam, an ultraviolet light source, a radioactive substance such as uranium, plutonium, cobalt-60 or a similar radioactive material, or another radiation source.

In accordance with still further aspects of the invention, layers of the layer-formed part may be exposed to radiation and then additional layers can be formed upon the previously-exposed layer-formed plastic part. Thus, the properties of subsequently-applied additional layers are not changed by having been subjected to the exposure of radiation. The subsequently-applied layers can be exposed to a secondary exposure of radiation to effect changes in properties of the subsequently-applied layers.

### BRIEF DESCRIPTION OF THE DRAWINGS

The preferred and alternative embodiments of the present invention are described in detail below with reference to the following drawings.

FIG. 1 is a diagram of a system for producing layer-formed plastic parts in accordance with an embodiment of the present invention;

FIG. 2A is an enlarged, top cross-sectional view of a radiating device of the system of FIG. 1 in accordance with an embodiment of the present invention;

FIG. 2B is a side perspective view of the radiating device of FIG. 2A;

FIG. 3A is a side elevational view of a part being partially shielded from irradiation using a shielding device;

FIG. 3B is a side elevational view of a part being partially shielded from irradiation using a different masking device,

FIG. 4 is a flowchart of a routine for creating and irradiating a layer-formed plastic part according to an embodiment of the present invention;

FIG. 5 is a flowchart of a routine for creating and irradiating individual layers of a plastic part according to an embodiment of the present invention;

FIG. 6 is a graph plotting elastic modulus versus radiation dosage demonstrating effects in accordance with an embodiment of the present invention;

FIG. 7 is a graph plotting percentage elongation versus radiation dosage demonstrating effects in accordance with an embodiment of the present invention; and

FIG. 8 is a graph plotting ultimate tensile strength versus radiation dosage demonstrating effects in accordance with an embodiment of the present invention.

### DETAILED DESCRIPTION OF THE INVENTION

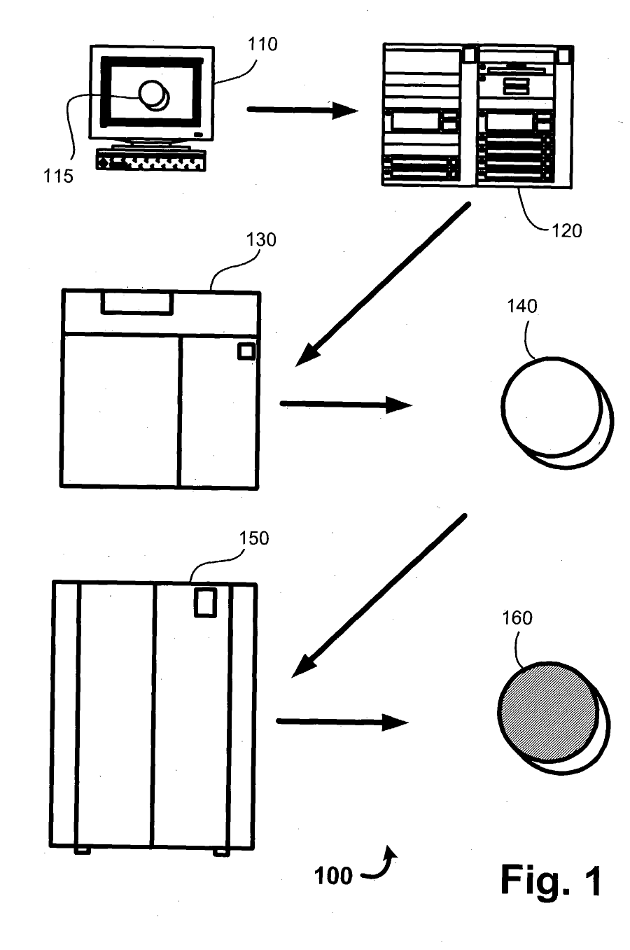

The present invention relates to methods and systems for changing the material properties of a layer-formed plastic part. Many specific details of certain embodiments of the invention are set forth in the following description and in FIGS. 1-8 to provide a thorough understanding of such embodiments. One skilled in the art, however, will understand that the present invention may have additional embodiments, or that the present invention may be practiced without several of the details described in the following description.

By way of overview, embodiments of the present invention include methods and systems for changing a property of a layer-formed plastic part. In a representative embodiment of a method in accordance with the present invention, an electromagnetic radiation source is provided and the layer-formed plastic part is positioned within a potential exposure range of the electromagnetic radiation source. An exposure of radiation from the electromagnetic radiation source operable to change the property of the layer-formed plastic part from the existing state to an altered state is determined. The layer-formed plastic part is then exposed to the radiation to change the property of the layer-formed plastic part to the altered state. As a result, a layer-formed part formed by selective laser sintering, fused deposition modeling, or a similar technique can be made to have more desirable properties.

FIG. 1 is a diagram of a system 100 for producing a layer-formed plastic part having at least one changed property in accordance with an embodiment of the present invention. At a design workstation 110, a design 115 of the layer-formed plastic part is created. The design 115 is received from the workstation 110 by a computer 120 programmed for transforming computer-aided designs to layer-formed plastic part creation instructions. The computer 120 generates the instructions for creating the layer-formed plastic parts and directs a production device 130 to create the layer-formed plastic part 140. The production device 130 could be a selective laser sintering (SLS) device for selectively depositing successive layers of plastic powder on a build surface and then sintering or melting the layers with a laser to solidify them. Alternatively, the production device 130 could be a fused deposition modeling (FDM) device equipped with heatable extruding nozzles for selectively melting filaments of plastic and selectively depositing them on a build surface. Using either SLS or FDM technology, the production area generally is kept at a temperature close to but just below the melting temperature of the plastic material being used. Because the temperature is close to a melting point of the plastic material, only a relatively small amount of energy being introduced by virtue of the laser or heatable nozzle will melt the plastic material to form it. At the same time, because the temperature is below the melting point of the plastic material, after the plastic material has been sintered or deposited, it solidifies to form a solid layer. The resulting layer-formed plastic part 140, particularly in the case of SLS technology, may be conjoined to a scrap substrate of plastic material that can be removed to present the layer-formed plastic part 140.

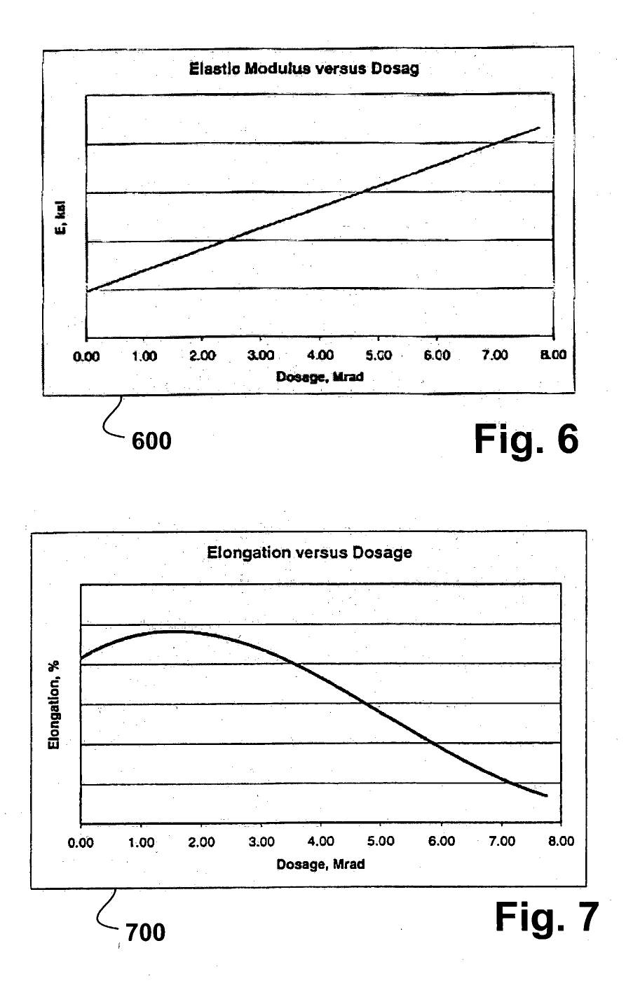

As further shown in FIG. 1, in this embodiment, the layer-formed plastic part 140 is then introduced to a radiation exposure station 150. At the radiation exposure station 150, the layer-formed plastic part 140 is submitted to an exposure of radiation from an electromagnetic radiation source (not shown in FIG. 1). Submitting the layer-formed plastic part 140 to the exposure of radiation can change one or more properties of the layer-formed plastic part 140, as will be further described in more detail below in connection with FIGS. 6, 7, and 8.

In general, submitting the layer-formed plastic part 140 to the exposure of radiation at the radiation exposure station affects the molecular structure of the plastic material from which the layer-formed plastic part is created. Exposing the plastic material to a radiation source can result in cross-linking of molecular chains of the plastic. In other words, introducing energy in the form of electromagnetic radiation can provide energy needed to form additional molecular bonds within the plastic material. These additional bonds may result in larger molecular chains and molecules having greater molecular weights, higher chain-linked densities, or other changed properties. Changing the molecular chains thereby changes properties of the part formed from the, plastic material, as will be further described below in connection with FIGS. 6, 7, and 8.

Alternatively, depending on the chemical composition of the plastic material, exposing the plastic material to an electromagnetic radiation source can result in chain-scissioning of the molecular chains. Chain-scissioning breaks atomic bonds within the plastic and reduces the atomic weight of the molecular chains. Chain-scissioning, therefore, also can change the properties of the plastic materials from which the layer-formed parts are made, as will be further discussed below.

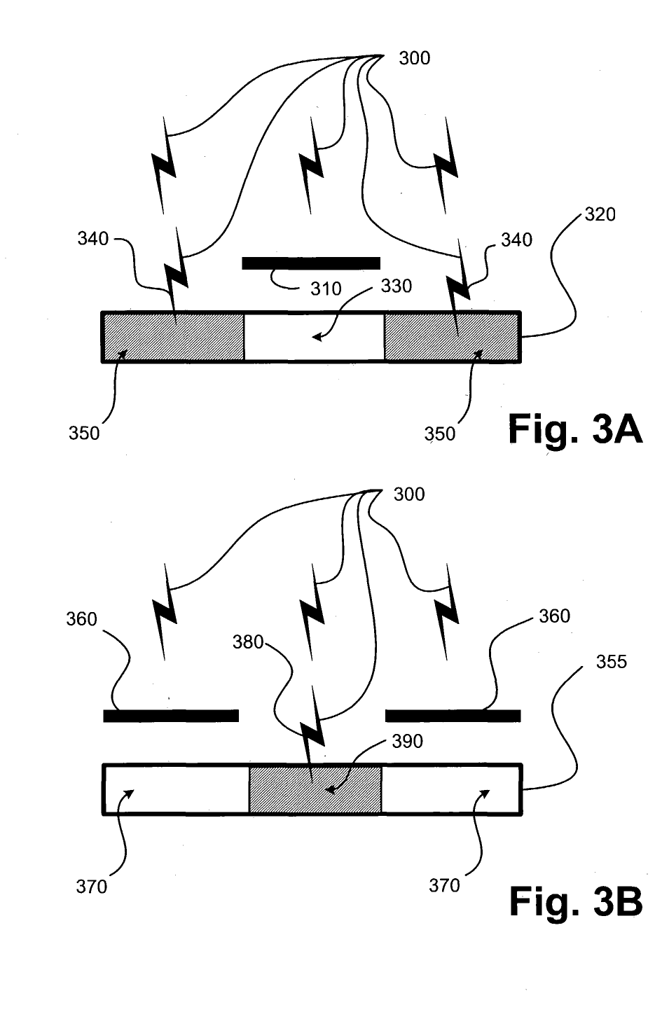

In either case, returning to FIG. 1, the layer-formed plastic part 140 is submitted to the radiation exposure station 150, and an altered layer-formed plastic part 160 is created (cross-hatching of the altered layer-formed plastic part 160 represent that properties of the part 160 have been changed by exposure to radiation, as cross-hatching also symbolizes below with regard to FIGS. 3A and 3B). As will be further described below, the altered layer-formed plastic part 160 will have different properties from the original layer-formed plastic part 140. The altered layer-formed plastic part 160, for example, may be stronger and more rigid than the original layer-formed plastic part 140. Alternatively, depending on the plastic material used and the exposure of radiation selected, the altered layer-formed plastic part 160 may be more deformable and more flexible than the original layer-formed plastic part 140. These properties and others thereby can be changed by the exposure to radiation to meet desired criteria for the altered layer-form ed plastic part 160.

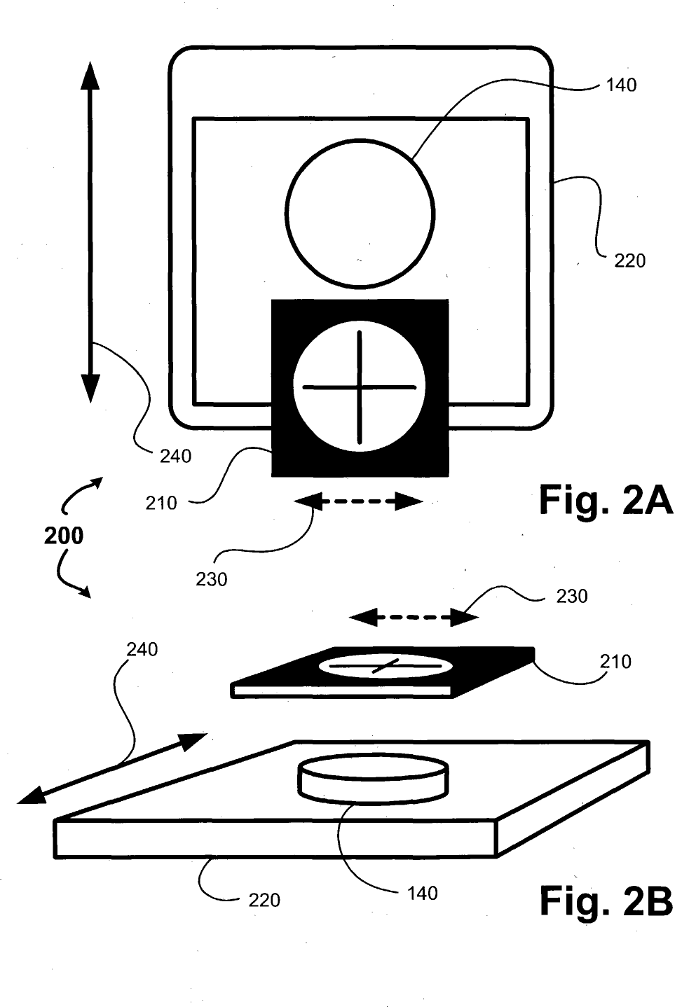

FIG. 2A shows a top elevational view of a radiating device 200 that may be used to change the properties of the layer-formed plastic part 140 (e.g. the radiation exposure station 150 of FIG. 1). FIG. 2B shows a side perspective view of the radiating device 200 of FIG. 2A. The radiating device 200 includes a controllable radiation source 210 and a controllable presentation device 220, both of which are used to apply an exposure of radiation to the layer-formed plastic part 140.

The radiation source 210 may be an electron beam source, an ultraviolet light source, a radioactive material such as uranium, plutonium, or cobalt-60, or any other suitable radiation source that can apply a desired exposure of radiation to the layer-formed plastic part 140. Generally, a radiation source 210 operable to provide energy on the order of ten mega electron volts (10 meV) is desirable to provide adequate penetration of the layer-formed plastic part 140. Other radiation sources providing greater or lesser energy levels may also be successfully employed. Typically, higher energy radiation sources can be used, however, appropriate shielding and safety precautions may be advisable. It will be appreciated that the power output of the radiation source 210 can be modulated to determine how much time the layer-formed plastic part 140 should be exposed to the radiation source 210 to achieve the desired result, thus determining the throughput rate of the process.

In addition to modulating power output of the radiation source 210, exposure of the layer-formed plastic part 140 to the radiation source 210 may be controlled by moving the layer-formed plastic part 140 relative to the radiation source 210. This movement can be accomplished by moving the presentation device 220 relative to the radiation source 210, moving the radiation source 210 relative to the presentation device 220, or some combination of both. In the embodiment shown in FIGS. 2A and 2B, the radiation source 210 moves side-to-side along the dotted-line axis 230, whereas the presentation device 220 moves back-and-forth along the solid-line axis 240. Movement of both the radiation source 210 and the presentation device 220 allows for complete coverage of a layer-formed plastic part 140 disposed on the presentation device 220. It will be appreciated that the radiation source 210 could be stationary, and the presentation device 220 could be articulable along both axes 230 and 240, or the presentation device 220 could be stationary and the radiation source 210 could be articulable along both axes 230 and 240 or otherwise moveable.

In addition, directing of an output of the radiation device 210 could be accomplished through electromagnetic means. For example, just as an output of a beam source in a cathode ray tube (CRT) display may be directed by positioning controllable magnetic plates alongside the beam source, the output of the radiation source 210 could be similarly controllable in the radiating system 200. By controlling electric current applied to magnetic plates situated near the radiation source 210, the output of the radiation source could be steered across a surface of the presentation device 220 and, thus, directed over a surface of the layer-formed plastic part 140.

FIGS. 3A and 3B show additional ways in which an exposure of radiation 300 from a radiation source (not shown in FIGS. 3A and 3B) can be controlled. More specifically, FIGS. 3A and 3B show how radiation-blocking shields 310 can be used to prevent selected sections of layer-formed plastic parts 320 from being exposed to radiation. Radiation 300 is generally directed toward the layer-formed plastic parts 320.

In FIG. 3A, a single radiation-blocking shield 310 is positioned over a central portion 330 of the layer-formed plastic part 320. The radiation-blocking shield 310 blocks the radiation 300. As a result, the central portion 330 is not reached by the radiation 300 and the properties of that central region 330 are not affected. On the other hand, of the radiation 300 applied, some radiation 340 reaches outer portions 350 of the layer-formed plastic part 320, affecting the properties of the outer portions 350 (as reflected by the cross-hatching as in FIG. 1).

In FIG. 3B, a pair of radiation-blocking shields 360 are positioned over outer portions 370 of the layer-formed plastic part 320. The radiation-blocking shields 360 block the radiation 300. As a result, the outer portions 370 are not reached by the radiation 300 and the properties of the outer regions 370 are not affected. On the other hand, of the radiation 300 applied, some radiation 380 reaches a central portion 390 of the layer-formed plastic part 320, affecting the properties of the central portion 390 (as reflected by the cross-hatching as in FIG. 1).

Thus, in addition to relative movement of the radiation source and the layer-formed plastic part as shown in FIGS. 2A and 2B, shielding also can be used to selectively control the exposure of radiation of the layer-formed plastic part 320. It will be appreciated that such radiation-blocking shields 310 could be manually applied to the layer-formed plastic parts 320, or could be deployed within a radiation exposure station 150 (FIG. 1) between the radiation source and the layer-formed plastic part 140. It will also be appreciated that the shields 310 can have varying thicknesses and densities across a width of the shields 310 orthogonal to the propagation of the radiation 300 such that portions of the layer-formed part 320 disposed behind or beneath the shield 310 can sustain a varied exposure to the radiation as a function of the varying thicknesses and densities of the shield 310 over the portions of the layer-formed part 320.

Regardless of the means employed to localize exposure to the radiation, selectively exposing one or more portions of a layer-formed plastic part allows for different portions of a layer-formed part to have different properties. For example, SLS or FDM might be used to craft a blade/disk or “blisk,” which is a disk having blades extending from its outer edges. It may be desirable that the central disk be rigid, while keeping the blades more flexible. Thus, if a rigid plastic is used and exposure to radiation will make the plastic more pliable, a shield might be applied over the central disk portion of the blisk before exposing it to radiation. After exposure, the central disk portion should remain more rigid, while the blade portion will become more pliable. Conversely, if a flexible plastic is used and exposure to radiation will make the plastic more rigid, a shield might be applied over the outer blade portion of the blisk before exposing it to radiation. After exposure, the central disk portion should become more rigid, while the blade portion will remain more pliable. Thus, controlling specific exposure to the radiation can be used to manifest different properties in the same layer-formed plastic part.

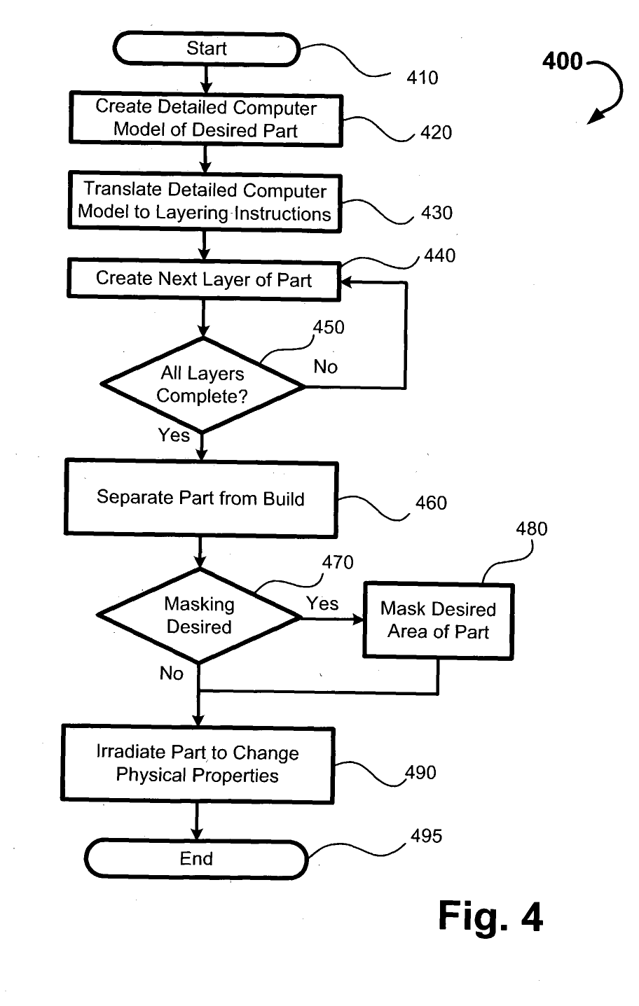

FIG. 4 is a flowchart of a routine 400 for creating and irradiating a layer-formed plastic part created using SLS according to an embodiment of the present invention. The routine 400 is tailored to a process for irradiating layer-formed plastic parts that already have been completely formed. At a block 410 the routine begins. At a block 420, a detailed computer model of the part is designed at a workstation 110 (FIG. 1). At a block 430, from the detailed computer model of the part, sintering instructions are generated to direct the formation process. At a block 440 a next layer of the part is sintered. At a decision block 450, it is determined if all the layers of the layer-formed plastic part have been sintered. If not, the routine 400 loops to the block 440 where the next layer of the part is sintered. However, if it is determined at the decision block 450 that all the layers have been sintered, the routine 400 proceeds to a block 460 where the layer-formed plastic part is separated from the build. In a conventional SLS formation routine, the routine would end with this step.

In the embodiment shown in FIG. 4, at a block 470, before radiation is applied to the layer-formed plastic part, at a decision block 470 it is determined if any shielding is desired to shield part of the layer-formed plastic part from the exposure to radiation. If so, at a block 480, a shield is applied over the part for which exposure to radiation is not desired. On the other hand, if no shielding is desired, at a block 490 the part is irradiated as previously described to change at least one of the properties of the layer-formed plastic part. After the layer-formed plastic part has been submitted to a desired exposure of radiation, the routine 400 ends at a block 495.

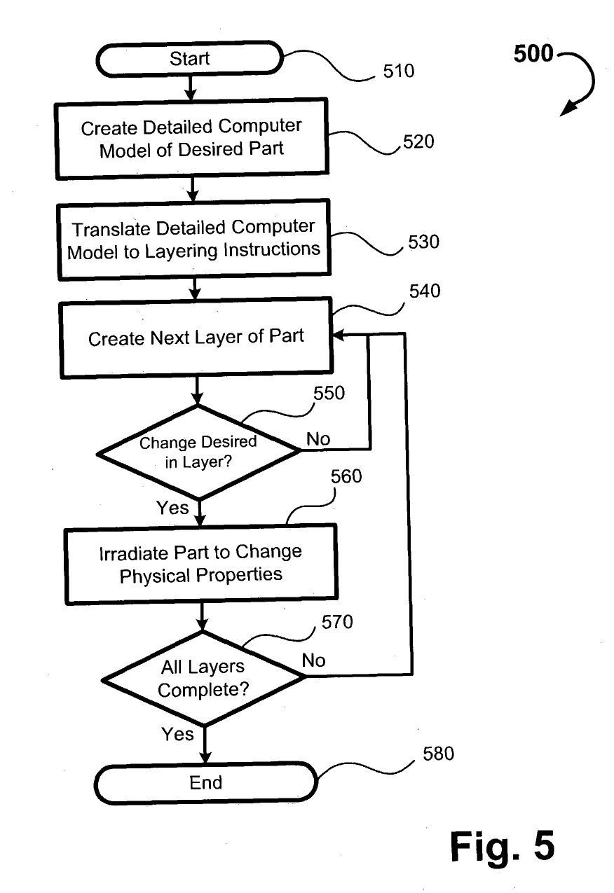

FIG. 5 is a flowchart of a routine 500 for irradiating individual layers of a plastic part during formation of a layer-formed plastic part. At a block 510 the routine begins. At a block 520, a detailed computer model of the part is designed at a workstation 110 (FIG. 1). At a block 530, from the detailed computer model of the part, layering instructions are generated to direct the formation process. At a block 540 a next layer of the part is formed. At a decision block 550, it is determined if changes in the properties of the layer just formed which can be altered by exposure to radiation are desired. If not, the routine 500 loops to the block 540 for creation of the next layer of the part. On the other hand, if changes in the properties are desired, at a block 560 the layer just formed is exposed to radiation to change its properties. At a decision block 570 it is determined if all the layers of the layer-formed part have been completed. If not, the routine 500 loops to the block 540 where the next layer of the part is formed. However, if it is determined at the decision block 570 that all the layers have been formed, the routine 500 ends at a block 580.

It will be appreciated that rather than changing properties in discrete, individual layers, the routine 500 of FIG. 5 could be adapted to effect a gradation of properties of layers of a part. This gradation may result from successively exposing some layers to more exposures of radiation than others. For example, rather than exposing a single layer to an exposure of radiation then not exposing the next layer to radiation, each layer might be exposed to a same exposure of radiation. If the radiation permeates successive layers, then earlier-deposited layers may be exposed to a greater composite exposure of radiation than subsequently-deposited layers. This exposure can effect desirable changes in the properties of earlier-deposited layers that are different than those of subsequently-deposited layers.

Using embodiments of the present invention, a number of properties of layer-formed plastic parts can be changed. FIG. 6 is a graph 600 plotting elastic modulus versus radiation dosage demonstrating effects in accordance with an embodiment of the present invention. More specifically, for a representative layer-formed plastic material, the graph shows how a greater modulus E, indicating increased stiffness necessitating a larger load to deform, increases with exposure to radiation. Accordingly, if it is desired that a layer-formed plastic part have a greater modulus than is inherent in the layer-formed plastic part produced by SLS, FDM, or a similar technique, the layer-formed plastic part can be exposed to radiation as specified by the present invention. Exposure to radiation may therefore increase the modulus of the layer-formed plastic part, meeting the desired objectives for the part.

FIG. 7 is a graph 700 plotting percentage elongation versus radiation dosage for a representative layer-formed thermoplastic material. The percentage elongation represents to what extent the material can be stretched without breaking. As the graph shows, exposure to radiation has a pronounced effect on elongation. Initially, exposure to radiation generally may cause cross-linking of molecular chains. As a result, as the graph 700 shows, percentage elongation initially increases, making the part more elastic. However, as the exposure to radiation continues to increase, percentage elongation declines indicating the part is less elastic. Accordingly, exposure to radiation allows the layer-formed plastic part to be formed with a higher percentage elongation or a lower percentage elongation, depending on the exposure dosage.

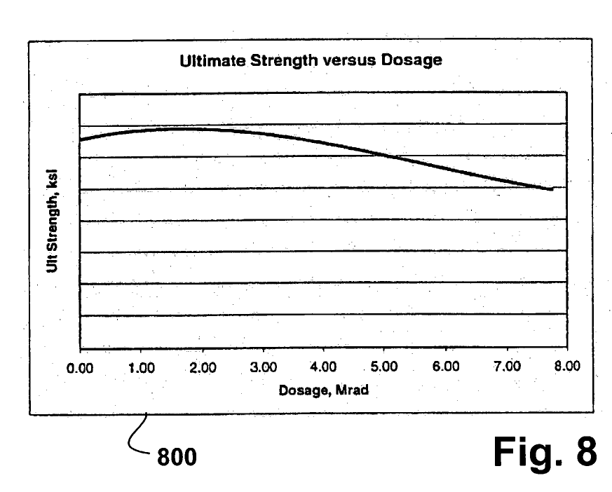

FIG. 8 is a graph plotting ultimate tensile strength versus radiation dosage for a representative layer-formed thermoplastic material. Increased ultimate tensile strength signifies that the material is stronger but less flexible. On the other hand, decreased tensile strength signifies that the material is less strong but more flexible. As is the case with percentage elongation (FIG. 7), exposure to radiation initially causes the ultimate tensile strength to increase. However, as the exposure to radiation increases, the ultimate tensile strength decreases. Thus, if greater ultimate tensile strength is desired, the layer-formed plastic part should be subjected to a small radiation exposure. On the other hand, if greater flexibility is desired, a larger dose of radiation should be applied.

A wide range of properties can be changed with the application of radiation to cross-link or chain-scission layer-formed plastic parts. For example, impact resistance, viability in different operating temperature ranges, and flammability all can be changed by cross-linking and chain-scissioning. Accordingly, even if layer-formed parts created using SLS, FDM, or similar techniques do not possess the properties desired, exposure to radiation can be used to transform the layer-formed plastic parts to have desired characteristics. Accordingly, using embodiments of the present invention, the benefits of being able to produce plastic parts using SLS or FMD can be extended by having both easily producible parts and tailorable, improved properties as well.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for changing a property of a layer-formed plastic part comprised of at least one plastic material, the method comprising:
providing an electromagnetic radiation source;
positioning the layer-formed plastic part within a potential exposure range of the electromagnetic radiation source;
determining an exposure of radiation from the electromagnetic radiation source operable to change a property of the layer-formed plastic part from an existing state to an altered state; and
exposing the layer-formed plastic part to the exposure of radiation to change the property to the altered state.

2. The method of claim 1, wherein determining the exposure of radiation from the electromagnetic radiation source operable to change the property of the layer-formed plastic part from the existing state to the altered state includes:
recognizing the existing state of the property of the layer-formed part;
identifying a desired state of the property;
identifying the exposure of radiation to change the property of the layer-formed plastic part such that the altered state reaches the desired state.

3. The method of claim 1, wherein the layer-formed plastic part is formed using at least one of selective laser sintering and fused deposition modeling.

4. The method of claim 1, wherein the exposure of electromagnetic radiation is controlled by relative movement of the layer-formed plastic part and the electromagnetic radiation source.

5. The method of claim 4, wherein the layer-formed plastic part is moved relative to the source of the electromagnetic radiation.

6. The method of claim 4, wherein the source of the electromagnetic radiation is moved relative to the layer-formed plastic part.

7. The method of claim 4, wherein the exposure of radiation is controlled by at least partially directing a discharge of radiation from the electromagnetic radiation source.

8. The method of claim 7, wherein the exposure of radiation is controlled by manipulating at least one magnetic field through which the radiation from the electromagnetic radiation source will pass.

9. The method of claim 1, wherein the exposure of radiation is controlled by selectively positioning a radiation-blocking shield between the layer-formed plastic part and the electromagnetic radiation source such that at least part of the layer-formed plastic part is shielded from the radiation source.

10. The method of claim 1, wherein the property to be changed is one of physical strength, elongation, modulus, impact resistance, operating temperature range, heat capacity, flammability, conductance, and emittance.

11. The method of claim 10, wherein the electromagnetic radiation source and the exposure of radiation are selected to at least one of cross-link and chain-scission molecules of the plastic material to change the property of the layer-formed plastic part to the desired state.

12. The method of claim 1, wherein the electromagnetic radiation is provided by one of an electron beam, an ultraviolet light source, or a radioactive material.

13. The method of claim 1, further comprising forming an additional layer upon the layer-formed plastic part after the exposure of radiation has been applied.

14. The method of claim 13, further comprising exposing the additional layer to a secondary exposure of radiation.

15. A method for producing a layer-formed plastic part comprised of at least one plastic material, the method comprising:
forming at least one layer of a layer-formed plastic part;
determining an exposure of radiation from an electromagnetic radiation source operable to change a property of the layer from an existing state to an altered state;
exposing the layer to the exposure of radiation to change the property to the altered state; and
forming an additional layer of the layer-formed plastic part onto the previously-formed layer.

16. The method of claim 15, wherein determining the exposure of radiation from the electromagnetic radiation source operable to change the property of the layer-formed plastic part from the existing state to the altered state includes:
recognizing the existing state of the property of the layer;
identifying a desired state of the property;
identifying the exposure of radiation to change the property of the layer such that the altered state reaches the desired state.

17. The method of claim 15, wherein the layer-formed plastic part is formed using at least one of selective laser sintering and fused deposition modeling.

18. The method of claim 15, further comprising exposing a plurality of layers of the layer-formed plastic part to exposures of radiation.

19. The method of claim 18, further comprising varying the exposures of radiation to which the layers of the layer-formed plastic part to differently change the properties of respective layers.

20. The method of claim 18, further comprising varying the electromagnetic radiation source to differently change the properties of respective layers.

21. The method of claim 15, wherein the exposure of electromagnetic radiation is controlled by relative movement of the layer and the electromagnetic radiation source.

22. The method of claim 21, wherein the layer is moved relative to the source of the electromagnetic radiation.

23. The method of claim 21, wherein the source of the electromagnetic radiation is moved relative to the layer.

24. The method of claim 15, wherein the exposure of radiation is controlled by targeting discharge of radiation from the electromagnetic radiation source.

25. The method of claim 24, wherein the exposure of radiation is controlled by manipulating at least one magnetic field.

26. The method of claim 15, wherein the exposure of radiation is controlled by selectively positioning a radiation-blocking shield between the layer-formed plastic part and the electromagnetic radiation source such that at least part of the layer-formed plastic part is shielded from the radiation source.

27. The method of claim 15, wherein the property to be changed is one of physical strength, elongation, modulus, impact resistance, operating temperature range, heat capacity, flammability, conductance, and emittance.

28. The method of claim 27, wherein the electromagnetic radiation source and the exposure of radiation are selected to at least one of cross-link or chain-scission molecules of the plastic material to change the property of the layer-formed plastic part to the desired state.

29. The method of claim 15, wherein the electromagnetic radiation is provided by one of an electron beam, an ultraviolet light source, or a radioactive material.

30. A system for changing a property of a layer-formed plastic part comprised of at least one plastic material, the system comprising:
an electromagnetic radiation source;
a part presentation device configured to receive the layer-formed plastic part and present the layer-formed plastic part to the electromagnetic radiation source; and
an exposure control device operably coupled with at least one of the electromagnetic radiation source and the part presentation device, the exposure control device being configured to selectively expose the layer-formed plastic part to an exposure of radiation generated by the electromagnetic radiation source.

31. The system of claim 30, wherein the layer-formed plastic part is formed using at least one of selective laser sintering and fused deposition modeling.

32. The system of claim 30, wherein the exposure control device selectively exposes the layer-formed plastic part to the electromagnetic radiation source by moving at least one of the part presentation device and the electromagnetic radiation source.

33. The system of claim 30, further comprising a radiation directing device configured to direct a discharge of radiation from the electromagnetic radiation source.

34. The system of claim 33, wherein the radiation directing device includes a magnetic channeling system configured to direct the discharge of radiation by manipulating a magnetic field.

35. The system of claim 30, further comprising a radiation-blocking shield configured to be positioned between the layer-formed plastic part and the electromagnetic radiation source such that at least part of the layer-formed plastic part is shielded from the radiation source.

36. The system of claim 30, wherein the property to be changed is one of physical strength, elongation, modulus, impact resistance, operating temperature range, heat capacity, flammability, conductance, and emittance.

37. The method of claim 36, wherein the electromagnetic radiation source and the exposure of radiation are selected to at least one of cross-link and chain-scission molecules of the plastic material to change the property of the layer-formed plastic part to the desired state.

38. The system of claim 30, wherein the electromagnetic radiation source is one of an electron beam, an ultraviolet light source, or a radioactive material.

39. The system of claim 30, further comprising a layering production system operable to create the layer-formed plastic part such that a layer of the layer-formed plastic part is selectively exposed to the exposure of radiation then an additional layer is formed upon the layer-formed plastic part such that the additional layer is not subjected to the exposure of radiation.

40. A system for producing a layer-formed plastic part comprised of at least one plastic material, the method comprising:
a layer-forming production device configured to produce the layer-formed plastic part by forming at least one layer of plastic material;
an electromagnetic radiation source;
a part presentation device configured to receive the layer-formed plastic part and present the layer-formed plastic part to the electromagnetic radiation source;
an exposure control device operably coupled with at least one of the electromagnetic radiation source and the part presentation device, the exposure control device being configured to selectively expose the at least one layer of the layer-formed plastic part to an exposure of radiation generated by the electromagnetic radiation source; and
a control unit operably coupled with the layer-forming production device and the exposure control device, the control unit being configured to selectively direct the at least one layer to be exposed to the exposure of radiation after the forming of the at least one layer.

41. The system of claim 40, wherein the layer-forming production device produces the layer-formed plastic part using at least one of selective laser sintering and fused deposition modeling.

42. The system of claim 40, wherein the exposure control device selectively exposes the layer-formed plastic part to the electromagnetic radiation source by moving at least one of the part presentation device and the electromagnetic radiation source.

43. The system of claim 40, further comprising a radiation directing device configured to direct a discharge of radiation from the electromagnetic radiation source.

44. The system of claim 43, wherein the radiation directing device includes a magnetic channeling system configured to direct the discharge of radiation by manipulating a magnetic field.

45. The system of claim 40, further comprising a radiation-blocking shield configured to be positioned between the layer-formed plastic part and the electromagnetic radiation source such that at least part of the layer-formed plastic part is shielded from the radiation source.

46. The system of claim 40, wherein the property to be changed is one of physical strength, elongation, modulus, impact resistance, operating temperature range, heat capacity, flammability, conductance, and emittance.

47. The method of claim 46, wherein the electromagnetic radiation source and the exposure of radiation are selected to at least one of cross-link or chain-scission molecules of the plastic material to change the property of the layer-formed plastic part to the desired state.

48. The system of claim 40, wherein the electromagnetic radiation source is one of an electron beam, an ultraviolet light source, or a radioactive material.
